(19) United States
(12) Patent Application Publication
(10) Pub. No.: US 2022/0110346 A1
(43) Pub. Date: Apr. 14, 2022

(54) FROZEN FOOD PRODUCT FOR MICROWAVE COOKING

(71) Applicant: CJ CHEILJEDANG CORPORATION, Jung-gu, Seoul (KR)

(72) Inventors: Sung Eun BAE, Guro-gu, Seoul (KR); Hun Gu SAGONG, Jangan-gu, Suwon-si, Gyeonggi-do (KR); Sung Woo SHINE, Gwangjin-gu, Seoul (KR)

(21) Appl. No.: 17/298,212

(22) PCT Filed: Nov. 29, 2019
(86) PCT No.: PCT/KR2019/016758

§ 371 Date: May 28, 2021

(30) Foreign Application Priority Data
Nov. 29, 2018 (KR) 10-2018-0150692

(51) Int. Cl. A23L 5/10; A23L 13/60; A23L 7/196; A23L 13/00; A23L 19/00; A23L 23/00; A23L 3/36

(52) U.S. Cl. CPC A23L 5/15; A23L 13/67; A23L 7/1965; A23V 2002/00; A23L 19/03; A23L 23/00; A23L 3/36; A23L 13/06

(57) ABSTRACT

The present application relates to a frozen product for microwave cooking.

### TECHNICAL FIELD

The present application relates to a frozen product for microwave cooking.

### BACKGROUND ART

Today, modern people are widely using various instant foods due to the busy life patterns and the cultures of pursuing something convenient and fast. The kinds of instant foods, including side dishes or processed meat products, have become gradually more various, and a plurality of instant foods are taken together with various sauces that suit tastes of consumers.

Meanwhile, as microwave ovens are distributed, it becomes common to heat and cook foods with microwaves. The above-described instant foods also mostly frozen and refrigerated, and may be taken by heating the instant foods by using microwaves of the microwave oven. The microwave oven heats foods by using heat generated when molecules in electric fields of microwaves vibrate after the microwaves penetrate into the foods, and may efficiently heat the foods in a short time.

Meanwhile, heating may be concentrated to a specific portion of a food when the microwaves are used, and thus the food may be unevenly heated. Accordingly, even when the frozen food is heated with microwaves, still frozen portions and warmed portions may be present together due to the uneven heating, and when the frozen food is heated with the microwave until it is unfrozen, an excessively overheated portion may be dried or solidified.

The phenomenon may occur more severely in a frozen product, in which two or more foods are contained together, and in particular, when the temperature rising rates of two or more foods are different, heating patterns are different according to irradiation of microwaves, and thus, the temperatures of the two or more foods become different. For example, when a frozen product containing rice and processed meat, to which sauces are sprayed, is heated with microwaves of a microwave oven, the processed meat may not be sufficiently warmed when the ricer is suitably warmed, and the rice and the sauces may be overcooked and dried when the meat is suitably warmed.

Accordingly, researches and developments for preventing organoleptic qualities of foods from deteriorating due to uneven heating by reducing the difference of temperatures of cooked foods when the frozen products are cooked by using microwaves of microwave ovens are necessary.

### DISCLOSURE

### Technical Problem

The present application is to provide a frozen product for microwave cooking, which prevents organoleptic qualities of the frozen product from deteriorating by reducing a difference of the temperature of cooked foods due to uneven cooking when the frozen product including two or more frozen foods is cooked with microwaves.

### Technical Solution

In order to solve the above problem, the present application provides a frozen product for microwave cooking comprising: at least two kinds of frozen foods; and one or more frozen sauces, wherein temperature rising rates of the at least two kinds of frozen foods by irradiation of microwaves are different.

### Advantageous Effects

Since a frozen product for microwave cooking of the present application comprises sauces in the frozen form, even though the temperature rising rates of the frozen foods are different from each other, the temperature difference of cooked foods is much reduced, thereby preventing organoleptic qualities of the foods from deteriorating.

However, the effects of the present application are not limited to the above-mentioned effects, and other unmentioned effects may be clearly understood from the following description by an ordinary person in the art.

### DESCRIPTION OF DRAWINGS

FIG. 1 is a view exemplarily illustrating an arrangement relationship between two or more kinds of frozen foods and frozen sauces according to an example 1 of the present application, in which “a” denotes fried rice, “b” denotes beef patty, “c” denotes frozen sauces in the form of blocks, and “d” denotes carrots for Garnish.

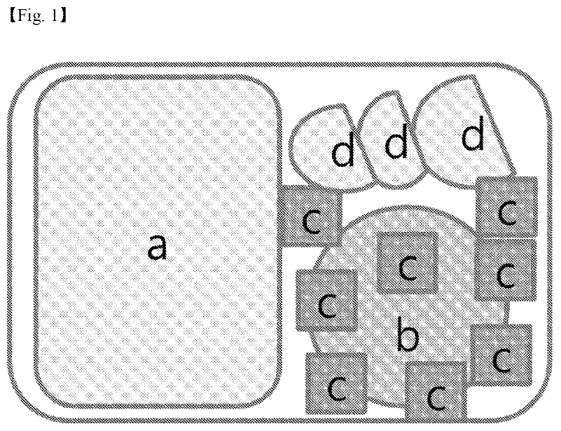

### MODE FOR INVENTION

Hereinafter, the present application will be described in detail.

The present application provides a frozen product for microwave cooking.

The frozen product of the present application comprises at least two kinds of frozen foods and one or more frozen sauces.

Temperature rising rates of the at least two kinds of frozen foods by irradiation of microwaves in the same condition may be different. “Temperature rising rates are different” means that there is a difference between the temperature rising rates value of the frozen foods, and the temperature rising rates of the respective frozen foods may become different according to the type and content of components constituting the frozen foods, and cooking states of the frozen foods. In detail, it may mean that periods of time, for which the foods reach a minimum temperature for cooking of the foods, are different when the at least two kinds of frozen foods are heated at the same time.

The temperature rising rate means a change value of a temperature that rises for unit time when a material is heated with a unit calorie (unit: ° C./min J), and a material of a high temperature rising rate is easily heated and a material of a low temperature rising rate is heated with difficulty. For example, one of the at least two kinds of frozen foods, of which the temperature rising rate by irradiation of microwaves is high, may be a food having the highest content of carbohydrate, and for example, may be a food, of which the main materials are grain materials, such as rice, barley, beans, millet (foxtail millet, proso millet, Sorghum), wheat, and corn. Furthermore, one of the at least two kinds of frozen foods, of which the temperature rising rate by irradiation of microwaves is low, may be a food having the highest content of protein, and for example, may be a processed meat, such as ham, sausage, patty, a fried food, or a meat roasted with seasonings, which is manufactured while meat, such as beef, pork, or chicken, is used as a main material, or a processed seafood, such as fish, shells, a crustacean, or Mollusca, which is manufactured while a seafood is used as a main material. In more detail, the food included in the frozen product for microwave cooking, of which the temperature rising rate is lowest, may be a frozen meat or a frozen seafood, and the food, of which the temperature rising rate is highest, may be a food, such as rice, fried rice, herb rice, Bibimbap, seasoned rice, or baked rice, which is manufactured while gains are used as main materials. The frozen food, of which the temperature rising rate is low, may be a frozen food, in which the one or more frozen sauces are disposed.

Furthermore, the at least two kinds of frozen foods may further include a food that is manufactured while vegetables, such as potatoes, sweat potatoes, beans, green onions, onions, carrots, broccolis, cabbages, white radishes, chili, large green onions, garlic, paprika, green beans, eggplants, green pumpkins, zucchini pumpkins, and mushrooms, are used as main materials, or a food that is manufactured while fruits, such as apples, pears, peaches, bananas, tomatoes, mandarins, oranges, and kiwis, are used as main materials.

The arrangement of the frozen foods, of which the temperature rising rates are different, may be an arrangement, in which two or more kinds of frozen foods are disposed to be spaced apart from each other, or may be an arrangement, in which one food is disposed on another food in a superposed form. When the frozen foods are disposed in the superposed form, one food may be disposed to fully cover another food, or may be disposed to be superposed on another food in a part such that specific parts of the foods are disposed to be exposed.

The at least two kinds of frozen foods may be taken again only with heating by irradiation of microwaves after the completely cooked foods are rapidly frozen. The rapid freezing means a freezing scheme of causing a food material to experience a temperature range of −1° C. to 5° C. that corresponds to a maximum ice crystal generating band when the temperature of the food material is decreased through freezing. In general, because freezing quality is greatly influenced by freezing temperature and freezing speed and a smooth freezing speed may cause degradation of quality, such as destruction of tissues by increasing the sizes of the ice crystals, it is very important to control the ice crystals as the volumes of the ice crystals become larger than that of water. However, when the freezing speed is simply made faster, a large temperature difference is caused between the outside and the inside of the food, causing a change in the pH of the food material, discharge of salt to the outside of the tissue components, an uneven distribution of salt, a change in the properties of protein, and a collapse of colloid tissues in the interior of the food in the interior of the food, and a structural change, such as mechanical destruction or a collapse of cell tissues, also may be caused in the outside of the food. The rapid freezing may be performed at a temperature of −10° C. or less, for example, −13° C. or less, −15° C. or less, −17° C. or less, −20° C. or less, −23° C. or less, −25° C. or less, −27° C. or less, or −30° C. or less. When the rapid freezing is performed in the temperature range, the food is sufficiently frozen so that a degradation of organoleptic functions, such as dripping or destruction of tissues, does not occur in processes of keeping, unfreezing, or cooking the food. Furthermore, the rapid freezing may be performed for a time period of 3 minutes or 120 minutes. In detail, the rapid freezing may be performed for a period of time ranging from one lower limit selected from 3 minutes, 5 minutes, 7 minutes, 10 minutes, 13 minutes, 15 minutes, 17 minutes, and 20 minutes, and/or one upper limit selected from 120 minutes, 115 minutes, 110 minutes, 105 minutes, 100 minutes, 95 minutes, 90 minutes, 85 minutes, and 80 minutes. For example, they may be 3 minutes to 120 minutes, 5 minutes to 115 minutes, 7 minutes to 110 minutes, 10 minutes to 105 minutes, 13 minutes to 100 minutes, 15 minutes to 95 minutes, 17 minutes to 90 minutes, 20 minutes to 85 minutes, or 20 minutes to 80 minutes. When the rapid freezing is performed in the time range, the temperature of the interior of the food may be sufficiently decreased such that the food is sufficiently frozen, and the organoleptic qualities may be less decreased when the product is frozen.

The sauce refers to a thick liquid that is garnished to make the taste of the food better, and the kind of the sauce is not particularly limited and any sauce that is known in the art, to which the present application pertains, will be sufficient. The frozen sauce is a frozen sauce that is made by rapidly freezing a liquid sauce, and is liquefied again even only through heating according to irradiation of microwaves, for example, at a temperature of 40° C. or more, for example, a temperature of 43° C. or more, 45° C. or more, 47° C. or more, or 50° C. or more, and may be cover at least a part of an upper surface of the food that is unfrozen together.

The frozen sauce may further contain a gelling agent, such as gelatin, to facilitate freezing. The sauce containing the gelling agent may help maintain the form of the frozen sauce longer even when the temperature of the outside increases after the freezing, and the unfreezing may be delayed. Furthermore, when the temperature of the sauce that is unfrozen through heating by irradiation of microwaves becomes 70° C. or more, the properties of the structure of the gelling agent is changed so that the sauce is liquefied and covers at least a portion of the upper surface of the unfrozen food together, whereby an external state that appears as if the liquid sauce was sprayed originally may be realized.

Individual frozen sauces may be formed by freezing the frozen sauce in unit of 1 g or more, for example, 2 g or more, 3 g or more, 4 g or more, 5 g or more, 6 g or more, 7 g or more, 8 g or more, 9 g or more, 10 g or more, 11 g or more, 12 g or more, 13 g or more, 15 g or more, or 15 g or more, and the frozen sauces that are frozen in the individual units may be frozen in the frozen sauces having a specific 3 dimensional solid shapes, for example, in the form of blocks. The 3-dimensional solid shape, for example, may be a rectangular parallelepiped shape, but the present application is not limited thereto, and various shapes, such as a polyhedron (for example, a poly-prism, a poly-pyramid, or a truncated poly-pyramid), a cylinder, a cone, a truncated cone, a sphere, and a truncated sphere, are possible and may be any one or a combination of two or more of the listed shapes.

The total content of the frozen sauces may be 10 wt % to 20 wt % with reference to a total of 100 wt % of the frozen product for microwave cooking. In detail, the total content of the frozen sauces may be a content ranging from one lower limit selected from 10 wt %, 11 wt %, 12 wt %, 13 wt %, 14 wt %, and 15 wt %, to one upper limit selected from 20 wt %, 19 wt %, 18 wt %, 17 wt %, 16 wt %, and 15 wt %. As an example, the total content of the frozen sauces may be 10 wt % to 20 wt %, 11 wt % to 19 wt %, 12 wt % to 18 wt %, 13 wt % to 17 wt %, 14 wt % to 16 wt %, 14 wt % to 15 wt %, 15 wt % to 16 wt %.

Further, when the frozen sauces are included in the individual units, a content of at least one of the frozen sauces may be a content ranging from one lower limit selected from 1 wt %, 3 wt %, 5 wt %, 7 wt %, and 10 wt % with reference to a total of 100 wt % of the frozen product of the present application to one upper limit selected from 30 wt %, 27 wt %, 25 wt %, 23 wt %, and 20 wt %. As an example, the content of the at least one of the frozen sauces may be 1 wt % to 30 wt %, 3 wt % to 27 wt %, 5 wt % to 25 wt %, 7 wt % to 23 wt %, and 10 wt % to 20 wt %.

Furthermore, at least one of the frozen sauces may have a weight of 1 g or more, for example, 2 g or more, 3 g or more, 4 g or more, 5 g or more, 6 g or more, 7 g or more, 8 g or more, 9 g or more, 10 g or more, 11 g or more, 12 g or more, 13 g or more, 14 g or more, and 15 g or more.

Furthermore, a dielectric constant of the frozen sauce for a frequency of 2.45 GHz at 25° C. may 50 or more, for example, 51 or more, 52 or more, 53 or more, 54 or more, or 55 or more, and a loss factor of the frozen sauce may be 25 or more, for example, 25.1 or more, 25.2 or more, 25.3 or more, 25.4 or more, 25.5 or more, 25.6 or more, 25.7 or more, 25.8 or more, 25.9 or more, and 26 or more. As the dielectric constant becomes higher, a property of absorbing/keeping energy of electric fields of microwaves by the sauce becomes stronger, and as the loss factor becomes higher, a property, so called a shield effect, of absorbing energy of electric fields of the irradiated microwaves to convert the energy into the form of heat and preventing the electric fields of the microwaves from penetrating deep into or passing through the sauce becomes stronger. Accordingly, when the microwaves are irradiated din a state, in which a sauce of both a high dielectric constant and a high loss factor covers an upper side of the frozen food, the sauce on the upper side of the frozen food is heated fast whereas the frozen food, though which the electric fields of the microwaves penetrate or pass, cannot be sufficiently unfrozen and heated whereby the quality of the organoleptic qualities deteriorates. When the irradiation time of the microwaves is increased in order to solve the problems, the sauce may be overcooked or carbonated whereby the temperatures of the sauce on the upper side and the frozen food on the lower side cannot be increased with balance.

In the frozen product for microwave cooking of the present application, the one or more frozen sauces may be disposed on one of the at least two kinds of frozen foods, of which the temperature rising rate is lowest.

An arrangement of the frozen sauces refers to an arrangement, in which the frozen sauces are positioned on a surface of the frozen food, of which the temperature rising rate is low, while contacting the surface of the frozen food, and in more detail, means that the frozen sauces are positioned on a surface of the frozen food, on which the frozen food, of which the temperature rising rate is lowest, is exposed while not contacting another frozen food while contacting the surface of the frozen food.

Then, in particular, when the sauce that has the high loss factor, and moreover has the high dielectric constant is applied to the frozen food having the low temperature rising rate, a problem of uneven heating may occur during microwave heating. In order to solve the problem, the frozen food, of which the temperature rising rate is lowest, may be disposed to include a noncontact surface from the frozen sauce at a specific portion of the surface thereof. The frozen sauces may have in the form of the individual frozen sauces, for example, a 3-dimensional solid shape, and the solid-shaped frozen sauces may be disposed on an upper side or a surface of the frozen food to contact at least one surface of the frozen food and not to contact at least one surface of the frozen food, whereby the surface of the frozen food may include a specific exposed surface.

As the at least one surface of the frozen food does not contact the frozen food, the frozen food may secure a surface, by which the electric fields of the microwaves may penetrate into or pass through the frozen food on the lower side while not passing through the frozen food on the upper side, and accordingly, the frozen food may be sufficiently heated while the sauces are not burned even through the frozen sauces and the frozen food are heated for the same period of time. Furthermore, the liquefaction of the solid shaped frozen sauces may be delayed, and may at least a part of the upper surface of the food unfrozen together with the frozen sauce having the solid shape due to the irradiation of the microwaves while the frozen sauces are unfrozen as well, whereby an external state that appears as if the liquid sauce was sprayed originally may be realized. Accordingly, the frozen sauces are disposed on the upper side of, among the at least two frozen foods, the frozen food, of which the temperature rising rate is lowest, so that the amount of microwaves irradiated to the frozen food having the low temperature rising rate and the period of time, for which the microwaves are irradiated, may be increased, whereby the temperature rising of the frozen food having the lowest temperature rising rate may be expedited, and ultimately, a difference between the temperatures of the frozen food having the lowest temperature rising rate and the frozen food having the highest temperature rising rate after cooking by microwaves may be further reduced.

Furthermore, the above-described effect may be further maximized as the weights of the individual frozen sauce units become heavier for the same content of the frozen sauces included in the frozen product. For example, when the frozen sauces of 30 g are included in the frozen product, the noncontact surfaces of the frozen sauces and the frozen food may be further increased when three individual frozen sauce units of a weight of 10 g are provided than when ten individual frozen sauce units of a weight of 3 g are provided. Accordingly, a physical space, through which the electric fields of microwaves may penetrate or pass to the frozen food on the lower side may be further secured, and the liquefaction of the sauces themselves may be delayed whereby the difference between the temperatures of the sauces on the upper side and the frozen food on the lower side may be advantageously further reduced.

The at least two kinds of frozen foods and the sauces may be sealed as a packaged product to be provided as a frozen product. Then, the at least two frozen foods and the sauces may be sealed into a vacuum state to be completed blocked and closed from the outside. Meanwhile, the frozen product may be cooked through irradiation of microwaves, and may be cooked by irradiating microwaves while being seated in a packaged product. Accordingly, the packaged product may be formed of a microwave transmitting material, such as polyethyleneterephthalate, crystalized polyethyleneterephthalate, polypropylene, polyethylene, or polystyrene.

Hereinafter, the present application will be described in detail with reference to examples, comparative examples, and experimental examples.

However, the examples, the comparative examples, and the experimental example, which will be described below, are detailed examples of the present application, and the contents of the present application are not limited to the examples, the comparative examples, and the experimental example.

### Example 1

Fried rice of 165 g including rice of 80 wt %, patty of 60 g having a thickness of 15 mm, and carrots for Garnish of 30 g that are cut into a suitable size and blenched in boiled water for 1 minute or more were prepared and contained in a container after being sorted. In addition, after a gelling agent (gelatin) of 2 to 3 wt % was added to a half glaze sauce of 45 g and the sauce was poured into a cubic frame and cooled such that the weights of the individual sauces were 4 to 5 g, the individual sauces were frozen at a temperature of −30 to 18° C. to manufacture the frozen sauces in the form of blocks. The frozen sauces manufactured as described above were disposed on the beef patty, were sealed in vacuum, and were frozen at a temperature of −30° C. to 18° C. to manufacture a frozen product. The frozen product manufactured as described above was kept for one day or more at a temperature of −18° C. or less.

### Comparison Example 1

Fried rice of 165 g including rice of 80 wt %, patty of 60 g having a thickness of 15 mm, and carrots for Garnish of 30 g that are cut into a suitable size and blenched in boiled water for 1 minute or more were prepared and contained in a container after being sorted. A liquid half glare sauce of 45 g, to which a gelling agent (gelatin) of 2 to 3 wt % was added, was disposed on beef patty, was sealed in vacuum, and was frozen at a temperature of −30° C. to 18° C. The frozen product manufactured as described above was kept for one day or more at a temperature of −18° C. or less.

### Experimental Example 1

Identification of Deviation of Temperature after Heating

After the frozen packaged products manufactured in the Example 1 and the Comparative example 1 were heated for 6 minutes and 30 seconds in a microwave oven of 700 W, average temperatures, standard deviations, and variation factor values were calculated by opening the frozen packaged products and measuring the temperatures of fried rice, beef patty, and carrots for Garnish with a temperature measuring device (Testo inc.) and illustrated in Table 1. The variation factors are values obtained by dividing the standard deviations by the average values. The variation factors are used as indexes when data having different average values and standard deviations are used. In the experimental example, a high variation factor means that the temperature ranges of the foods are wide and indicates a large deviation of temperature.

TABLE 1

| | Beef patty | | Fried rice | | Carrots for Garnish | |
|---|---|---|---|---|---|---|
| | Example | Comparative | Example | Comparative | Example | Comparative |
| | 1 | example 1 | 1 | example 1 | 1 | example 1 |
| Average | 67.19 | 44.65 | 83.94 | 85.19 | 68.75 | 69.3 |
| temperature | | | | | | |
| (° C.) | | | | | | |
| Standard | 10.65 | 14.38 | 2.86 | 2.85 | 2.99 | 1.54 |
| deviation | | | | | | |
| Variation | 0.16 | 0.30 | 0.03 | 0.03 | 0.04 | 0.02 |
| factor | | | | | | |
| Minimum | 47 | 20.5 | 79.75 | 80.5 | 65.5 | 67.5 |
| temperature | | | | | | |
| (° C.) | | | | | | |

As a result, in the Example 1 and the Comparative example 1, it was identified that the average temperatures of the fried rice and the carrots for Garnish were hardly different. In contrast, it was identified that the average temperature and the minimum temperature of the beef patty, on which the sauces were disposed, were different by about 20° C. or more. In particular, in the Example 1, the minimum temperature was 47° C., by which a person can sufficiently feel warm, and was a level, by which excellent organoleptic qualities may be sufficiently reached even when a consumer takes the product, and in contrast, in the Comparative example 1, the average temperature itself failed to reach the minimum temperature of the Example 1 and the minimum temperature was a temperature of 25° C., by which a consumer cannot feel warm. Furthermore, it was identified that the variation factors also were different by 2 times or more, and this means that the uniform temperature improving effect of the Example 1 was better than that of the Comparative example 1.

It can be clearly seen from the above result that, when the sauces were frozen and provided to have a solid shape, the microwaves reach the frozen food before the frozen sauces were heated and became fluidic whereby the temperature may be further improved.

### Experimental Example 2

Identification of Distribution of Temperature According to Heating Time

After the frozen packaged product manufactured in the Example 1 was heated for 6 minutes and 30 seconds in a microwave oven of 700 W in a sealed state and the frozen packaged product manufactured in the Comparative example 1 was heated for 6 minutes and 30 seconds or 8 minutes in a microwave oven of 700 W in a sealed state, the average temperatures, the standard deviations, and the variation factor values were calculated in the same method as the Experimental example 1 and are illustrated in Table 2.

TABLE 2

| | Beef patty | | | Fried rice | | | Carrots for Garnish | | |
|---|---|---|---|---|---|---|---|---|---|
| | | Comparative | | | Comparative | | | Comparative | |
| | Example | example 1 | | Example | example 1 | | Example | example 1 | |
| | 6.5 | 6.5 | 8 | 6.5 | 6.5 | 8 | 6.5 | 6.5 | 8 |
| | minutes | minutes | minutes | minutes | minutes | minutes | minutes | minutes | minutes |
| Average | 67.19 | 44.65 | 69.23 | 83.94 | 85.19 | 84.52 | 68.75 | 69.3 | 68.78 |
| temperature | | | | | | | | | |
| (° C.) | | | | | | | | | |
| Standard | 10.65 | 14.38 | 12.50 | 2.86 | 2.85 | 3.25 | 2.99 | 1.54 | 5.38 |
| deviation | | | | | | | | | |
| Change | 0.16 | 0.30 | 0.18 | 0.03 | 0.03 | 0.04 | 0.04 | 0.02 | 0.08 |
| factor | | | | | | | | | |
| Minimum | 47.00 | 20.50 | 43.33 | 79.75 | 80.50 | 80.33 | 65.50 | 67.5 | 64.67 |
| temperature | | | | | | | | | |
| (° C.) | | | | | | | | | |

As can be seen in Table 2, it was identified that microwaves had to be irradiated to the frozen packaged product of the Comparative example 1 for 8 minutes to adjust the average temperature of the beef patty to the same level as that of the Example 1. However, it was identified that deterioration of quality, in which a surface of the fried rice was dried and moisture was leaked from the carrots for Garnish to cause wrinkles when the frozen packaged product of the Comparative example 1 was cooked for 8 minutes.

Until now, the preferred example, the comparative example, and the experimental example of the present application have been exemplarily described, but the scope of the present application is not limited to the example, the comparative example, and the experimental example, and an ordinary person in the art may properly change the present application without departing from the categories claimed in the present application.

1. A frozen product for microwave cooking comprising:
at least two kinds of frozen foods; and
one or more frozen sauces,
wherein temperature rising rates of the at least two kinds of frozen foods by irradiation of microwaves are different.

2. The frozen product of claim 1, wherein the one or more frozen sauces are disposed on one of the at least two kinds of frozen foods, of which the temperature rising rate is lowest.

3. The frozen product of claim 2, wherein the one of the at least two kinds of frozen foods, of which the temperature rising rate is lowest, includes a noncontact surface from the frozen sauce at a specific part of a surface thereof.

4. The frozen product of claim 2, wherein the one of the at least two kinds of frozen foods, of which the temperature rising rate is lowest, is a frozen meat or a frozen seafood.

5. The frozen product of claim 1, wherein the one or more frozen sauces are liquefied at a temperature of 40° C. or more.

6. The frozen product of claim 1, wherein the one or more frozen sauces contains a gelling agent.

7. The frozen product of claim 1, wherein a dielectric constant of the one or more frozen sauces for a frequency of 2.45 GHz at 25° C. is 50 or more, and a loss factor thereof is 25 or more.

8. The frozen product of claim 7, wherein a dielectric constant of the one or more frozen sauces for a frequency of 2.45 GHz at 25° C. is 55 or more, and a loss factor thereof is 26 or more.

9. The frozen product of claim 1, wherein a total content of the one or more frozen sauces is 10 wt % to 20 wt % with reference to a total of 100 wt % of the frozen product for microwave cooking.

10. The frozen product of claim 9, wherein a weight of the one or more frozen sauces is 1 g or more.

11. The frozen product of claim 10, wherein a weight of the one or more frozen sauces is 3 g or more.

12. The frozen product of claim 11, wherein a weight of the one or more frozen sauces is 10 g or more.
